(19) United States
(12) Patent Application Publication
(10) Pub. No.: US 2007/0248260 A1
(43) Pub. Date: Oct. 25, 2007

(54) Supporting a 3D presentation

(75) Inventor: Lachlan Pockett, Hervanta (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/409,500

(22) Filed: Apr. 20, 2006

(51) Int. Cl. G06K 9/00

(52) U.S. Cl. 382/154

(57) ABSTRACT

For supporting a three-dimensional presentation on a display, which presentation combines at least a first available image and a second available image, differences between a first calibration image and a second calibration image are detected. At least one of a first available image and a second available image are then modified to approach desired disparities between the first available image and the second available image based on the detected disparities between the first calibration image and the second calibration image.

### FIELD OF THE INVENTION

The invention relates to a method for supporting a three-dimensional presentation on a display, which presentation combines at least a first available image and a second available image. The invention relates equally to a corresponding apparatus and to a corresponding software program product.

### BACKGROUND OF THE INVENTION

Stereoscopic displays allow presenting an image that is perceived by a user as a three-dimensional (3D) image. To this end, a stereoscopic display directs information from certain sub-pixels of an image in different directions, so that a viewer can see a different picture with each eye. If the pictures are similar enough, the human brain will assume that the viewer is looking at a single object and fuse matching points on the two pictures together to create a perceived single object. The human brain will match similar nearby points from the left and right eye input. Small horizontal differences in the location of points will be represented as disparity, allowing the eye to converge to the point, and building a perception of the depth of every object in the scene relative to the disparity perceived between the eyes. This enables the brain to fuse the pictures into a single perceived 3D object.

The data for a 3D image may be obtained for instance by taking multiple two-dimensional images and by combining the pixels of the images to sub-pixels of a single image for the presentation on a stereoscopic display.

In one alternative, two cameras that are arranged at a small pre-specified distance relative to each other take the two-dimensional images for a 3D presentation.

FIG. 1 presents two cameras 1, 2 that are arranged at a small distance to each other. Cameras employed for capturing two-dimensional images for a 3D presentation, however, are not physically converged as in FIG. 1, since this would result in different image planes 3, 4 and thus projective warping of the resulting scene. In the perceived depth profile of a flat object, for instance, the middle of the flat object is perceived closer to the observer, while the sides vanish into the distance.

Instead, parallel cameras 1, 2 are used, which are arranged such that both image planes 3, 4 are co-planar, as illustrated in FIG. 2. Due to the small distance between the cameras 1, 2, the images captured by these cameras 1, 2 are slightly shifted in horizontal direction relative to each other, as illustrated in FIG. 3. FIG. 3 shows the image 5 of the left hand camera 1 with dashed lines and the image 6 of the right hand camera 2 with dotted lines.

A Euclidian image shift with image edge cropping is applied to move the zero displacement plane or zero disparity plane (ZDP) to lie in the middle of the virtual scene, in order to converge the images 5, 6.

In the context of the ZDP, disparity is a horizontal linear measure of the difference between where a point is represented on a left hand image and where it is represented on a right hand image. There are different measures for this disparity, for example arc-min of the eye, diopter limits, maximum disparity on the display, distance out of the display at which an object is placed, etc. These measures are all geometrically related to each other, though, so determining the disparity with one measure defines it as well for any other measure for a certain viewing geometry. When taking two pictures with parallel cameras, the cameras pick up a zero angular disparity between them for an object at infinite distance, and a maximum angular disparity for a close object, that is, a maximum number of pixels disparity, which depends on the closeness of the object and the camera separation, as well as on other factors, like camera resolution, field of view (FOV), zoom and lens properties. Therefore the horizontal disparity between two input images taken by two parallel cameras ranges from zero to maximum disparity. On the display side, there is a certain viewing geometry defining for instance an allowed diopter mismatch, relating to a maximum convergence angle and thus to a maximum disparity on the screen.

The image cropping removes the non-overlapping parts of the images 5, 6, and due to the Euclidian image shift, the remaining pixels of both images in the ZDP have the same indices. In the ZDP, all points in a XY plane lie on the same position on both left and right images, causing the effect of objects to be perceived in the plane of the screen. The ZDP is normally adjusted to be near the middle of the virtual scene and represents the depth of objects that appear on the depth of the screen. Objects with positive disparity appear in front of the screen and objects with negative disparity appear behind the screen, as illustrated in FIG. 4. FIG. 4 depicts the screen 7 presenting a 3D image, which is viewed by a viewer having an indicated inter pupil distance between the left eye 8 and the right eye 9. The horizontal Euclidian shift moves the ZDP and respectively changes all the object disparities relative to it, hence moving the scene in its entirety forwards or backwards in the comfortable virtual viewing space (CVVS). The image cropping and converging is illustrated in FIG. 5.

On the display side, the disparity may range from a negative maximum value for an object that appears at a back limit plane (BLP) and a maximum positive value for an object that appears at a frontal limit plane (FLP).

FLP and BLP thus provide limits in the virtual space as to how far a virtual object may appear in front of the screen or behind the screen. This is due to the difference between eye accommodation and eye convergence. The brain is used to the situation that the eyes converge on an object and focus to the depth at which this object is placed. With stereoscopic displays, however, the eyes converge to a point out of the screen while still focusing to the depth of the screen itself. The human ergonomic limits for this mismatch vary largely depending on the user; common limits are around 0.5-0.75 diopter difference. This also means that FLP and BLP may differ significantly depending on display and viewing distance.

An undesired Euclidian shift between a left hand image and a right hand image will change the plane that has zero disparity. This ultimately changes the distance of a virtual object that should appear at the depth of the screen, and also the distance of a virtual object that should appear at FLP and BLP.

For creating high quality 3D images, the alignment of the employed cameras 1, 2 is critical. Any camera misalignment will change the view of one captured image relative to the other, and the effect of misalignment will be more visible in the 3D scene as the brain of a viewer simultaneously compares the two displayed images it receives via each eye, looking for minute differences between the images, which give the depth information. These minute inconsistencies, which would normally not be picked up in a 2D image, suddenly become very apparent when viewing the image pair in a 3D presentation. Misalignments of this kind are unnatural for the human brain and result in a perceived 3D image of low quality. A very small misalignment might sometimes not be articulately noticeable by an inexperienced viewer, but when comparing 3D images, even tiny improvements in camera alignments are registered as improved image quality. An improved camera alignment will also be noticed to result in an increased ease of viewing, since even small misalignments may cause severe eye fatigue and nausea. A large misalignment will render image fusion impossible.

The deviation of a camera from an identical position with respect to another camera can be broken down into the six degrees of freedom of the camera. These are indicated in FIG. 5 by means of a Cartesian co-ordinate system. A camera can be shifted from an aligned position in direction of the X-axis, which corresponds to a horizontal shift, in direction of the Y-axis, which corresponds to a vertical shift, and in direction of the Z-axis, which corresponds to a shift forwards or backwards. Further, it can be rotated in θX direction, that is, around the X-axis, in θY direction, that is, around the Y-axis, and in θZ direction, that is, around the Z-axis.

The only desired displacement of a camera with respect to another camera in this system is a shift of a predetermined amount in direction of the X-axis. The resulting disparity of an object between the images captured is trigonometrically related to the distance of the object in the 3D presentation, with large disparities for close objects and no disparity for objects at infinite distance with parallel cameras. The disparities get scaled into output disparities along with the shifting of the ZDP and provide the required input for a 3D presentation as shown in FIG. 3.

A misalignment is caused by the sum of the motion vectors between these positions of two cameras in each of the directions indicated in FIG. 6. Thus, the image transformations caused by a displacement of one of the cameras can also be considered separately and summed up to create the complete sequence of transformations for the image compared to the desired image.

Different types of misalignment transformations cause a range of different horizontal and vertical shifts of points on an image captured by a left hand camera 1 relative to an image captured by a right hand camera 2. Vertical differences generally cause eye fatigue, nausea and fusibility problems. Horizontal differences result in artificially introduced disparities, which cause a warping of the perceived depth field.

Uniform artificial horizontal displacements across the entire scene cause a shift in the depth of the entire scene, moving it in or out of the screen, due to the shifting of ZDP, FLP and BLP, placing objects outside of the comfortable virtual viewing space (CVVS) and hence causing eye strain and fusion problems. The CVVS is defined as the 3D space in front and behind the screen that virtual objects are allowed to be in and be comfortably viewed by the majority of individuals. It has to be noted that the CVVS is conventionally referred to as comfortable viewing space (CVS). The term CVVS is used in this document, in order to provide a distinction to the comfortable viewing space of auto stereoscopic displays, which is the area that the human eye can be in to perceive a 3D scene. The CVVS is illustrated in FIG. 7. FIG. 7 depicts the screen 7 presenting a 3D image, which is viewed by a viewer having an indicated inter pupil distance between the left eye 8 and the right eye 9. The CVVS is located between a minimum virtual distance in front of the screen 7 and a maximum virtual distance behind the screen 7. Non-uniform horizontal shifts to parts of the image also cause sections of the image to be perceived at the wrong depth relative to the depth of the rest of the scene, giving an unnatural feel to the scene and so losing the realism of the scene.

Effects of X, Y and Z movements are strongly related to the distance of an object.

Generally, rotational movements between two cameras induce a change in the perspective plane angle and in the location of the perspective plane. This can be summed up as a trigonometrically linked Euclidian shift and keystone distortion. Movements in the X, Y and Z direction cause a change in camera point location and so a change in camera geometry, larger angular changes are noticed for objects at close distance while no change is experienced in objects at infinite distance.

Different misalignments in a single direction and their effects on a combined 3D image are illustrated in FIGS. 8a)-8f). In each of these Figures, the direction of misalignment is indicated, and in addition the resulting relation between an image 5 captured with a left hand camera 1 and an image 6 captured with a right hand camera 2. These diagrams are a representation of the movements of the projected image plane, but within the projected image plane all objects move differently depending on their 3D position. When considering FIGS. 6a)-6f), thus, the 3D effects and 3D geometry should be taken into account and not simply the presented 2D projection planes 5 and 6. A movement of the cameras causes different movements in each object relative to the diopter distance of the object.

In 3D imaging, differences between the images become much more apparent than in 2D imaging. Slight differences that are not noticed in 2D images become exaggerated in 3D images, as the brain is simultaneously looking at both images and comparing them, picking out tiny differences to use the information to see depth. For example, a shift by a single pixel of an object on each of the 2D images results in a small change of angle and will not be noticeable in a 2D presentation. In a 3D presentation, in contrast, the shift may change the perceived distance of an object considerably. The brain will pick up the artifacts, if an object seems out of place from where it should be.

FIG. 8a) illustrates more specifically the effect of a displacement of one of the cameras relative to the other camera in direction of the Y-axis. That is, one camera 1 is arranged at a higher position than the other camera 2. As a result, also the nearby content of the image 5 captured by one camera 1 is shifted in direction of the Y-axis compared to the content of the image 6 captured by the other camera 2. Such Y displacements are undesirable, as they cause each eye to perceive the scene at a different height, hence causing fusion problems.

FIG. 8b) illustrates the effect of a displacement of one of the cameras relative to the other camera in direction of the Z-axis. That is, one camera 2 is arranged further in the front than the other camera 1. As a result, the distance from each object in the scene changes, with the same horizontal and vertical offset from the camera, hence causes a chance in the angle of the light ray, causing a moving of the X and y position of each object and a scaling of each object in the scene. The scaling is related to the distance of the respective object. Generally, the displacement causes vertical shifts and horizontal shifts throughout the image. While having one camera further in the front than the other naturally changes the scaling, this effect is less significant, as it is related to the tan of the angle of incidence of the light ray from the object, and a small change in distance to the object will cause only a small change in the tan of the angle when the angle is small.

FIG. 8c) illustrates the effect of a displacement of one of the cameras relative to the other camera in direction of the X-axis. That is, the inter camera distance (ICD) deviates from a desired value, resulting in a change of the depth magnification. The depth magnification is the ratio of the depth that is perceived in the 3D image compared to the real depth in a captured scene. An increased ICD will increase the depth magnification. This causes convergence problems and also moves the ZDP backwards. A reduced ICD decreases the depth magnification. This causes a flat looking image.

FIG. 8d) illustrates the effect of a rotation of one of the cameras relative to the other camera around the Y-axis, that is, a displacement in θY direction. Such a rotation is referred to as convergence or divergence, respectively, or convergence angle misalignment. Any rotation of the camera gives a trigonometrically linked Euclidian shift and keystone distortion. The Euclidian aspect of this means that even a small convergence angle misalignment causes a large effect in the alignment of the content of the images 5, 6 in the direction of the X-axis, and hence a change in the ZDP. Moreover, the projected camera plane is warped. As a result, the height of objects on the lateral edges of the screen appears to be different for each eye, hence the different vertical position causes eye strain. Moreover, the non-linearity of the X axis causes a change in perceived depth, and the middle of the scene will hence appear closer to the observer then the side of the scene, causing flat walls to be perceived as bent.

The depth mapping is non-linear, it relates to the angles involved in the camera geometry. According to the present designation, negative disparities are behind the display, making the rear disparity larger than desired. If, for example, the cameras are twisted in, then there is a negative instead of a zero disparity detected for infinite distance. This means that distant objects have a larger negative screen disparity after an identical image shift than the BLP. As a result, fusion problems can occur. In extreme situations, it could cause a greater negative screen disparity than the human eyes can cope with, forcing the eyes to go wall eyed, meaning that the eyes are diverged from parallel and are looking for instance at opposite walls, which is unnatural as human eyes are not designed to diverge from parallel. All users have different eye separation so a different negative disparity will equal parallel rays for the eyes of different users. In a situation in which the cameras are twisted outwards, the opposite effect occurs to the mapping of the depth space. For example, if the real world ZDP is caused to be equivalent to be at 2m and the frontal limit to be at 1m, this means that objects that should be in the depth of the screen at 1m distance now appear in front of the screen at the front area of the CVVS, while objects that should appear in the front area of the CVVS now have too large disparities for enabling the human eye to fuse.

FIG. 8e) illustrates the effect of a rotation of one of the cameras relative to the other camera around the X-axis, that is, a displacement in θX direction. Such a rotation is referred to as pitch misalignment. Rotation around the X-axis, or pitch axis, creates a projective transformation of the content of the images 5, 6. This implies a vertical shift, a slight non-linearity along the vertical axis and keystone distortion, which results in a horizontal shift in the corners of the image causing a warping of the depth field.

FIG. 8f) illustrates the effect of a rotation of one of the cameras relative to the other camera around the Z-axis, that is, a displacement in θZ direction. This appears in the captured images 5, 6 as an image rotation or rotational misalignment. As a result, the orientation of objects appears to be different for each eye.

The Euclidian aspect of effects of a camera rotation, illustrated in FIGS. 8d) to 8f), tend to be more noticeable then effects of a camera shift, illustrated in FIGS. 8a) to 8c) due to normal object distance and geometry. For instance, a vertical displacement of an object at a distance of 2 meters due to a pitch misalignment by 0.1 degree will have a similar effect as a vertical displacement due to a relative vertical shift between the cameras of 3.5 mm.

Conventionally, cameras for capturing 3D images are accurately built into an electronic device at a fixed aligned position for capturing images for a 3D presentation. Two cameras may be fixed for instance by hinges, which are then used for aligning the cameras. Alternatively, the cameras could be fit rigidly onto a single cuboid block.

Such accurate arrangements require tight tolerances for camera mountings, which limits the device concept flexibility.

Moreover, even in an accurately set system there will inevitably occur some camera misalignment increasing eye fatigue. There are small misalignments in most hinge concepts, especially after ware. Misalignments can even occur in rigid candy bar devices, for instance when they are dropped or due to a heating of the device.

The tight 3D camera misalignment tolerances thus make the production of devices, which allow capturing images for a 3D presentation, rather complicated. Meeting the requirements is even more difficult with devices, for which it is desirable to be able to have rotating cameras for tele-presence applications.

In addition to the physical misalignment differences between cameras capturing an image pair, there may also be other types of mismatching between the images due to different camera properties, for example a mismatch of white balance, sharpness, granularity and various other image factors.

Moreover, the employed lenses may cause distortions between a pair of images. Even if left hand and right hand camera component employ a common lens, the left and right image will use different parts of the lens. Therefore, lens distortions that are non-uniform across the image will become apparent, as the left and right image will experience the distortions differently. Examples of lens based image distortions are differences in image scaling, differences in color balance, differences in barrel distortion, differences in pincushion distortion, etc. Pincushion distortion is a lens effect, which causes horizontal and vertical lines bend inwards toward the center of the image. Barrel distortion is a lens effect, in which horizontal and vertical lines bend outwards toward the edges of the image.

### SUMMARY OF THE INVENTION

It is an object of the invention to improve the quality of a 3D presentation, while easing the requirements on the generation of the images that are used for the 3D presentation.

A method for supporting a 3D presentation on a display, which presentation combines at least a first available image and a second available image, is proposed. The method comprises detecting disparities between a first calibration image and a second calibration image. The method further comprises modifying at least one of a first available image and a second available image to approach desired disparities between the first available image and the second available image based on the detected disparities between the first calibration image and the second calibration image.

Moreover, an apparatus is proposed. For supporting a 3D presentation on a display, which presentation combines at least a first available image and a second available image, the apparatus comprises a disparity detection component adapted to detect disparities between a first calibration image and a second calibration image. The apparatus further comprises an image adaptation component adapted to modify at least one of a first available image and a second available image to approach desired disparities between the first available image and the second available image based on the detected disparities between the first calibration image and the second calibration image.

Finally, a software program product is proposed, in which a software program code for supporting a three-dimensional presentation on a display is stored in a readable medium. The presentation is assumed to combine at least a first available image and a second available image. When being executed by a processor, the software program code realizes the proposed method. The software program product can be for instance a separate memory device or an internal memory for an electronic device.

The invention proceeds from the consideration that instead of using two perfectly aligned camera components with perfectly matched camera component properties for capturing at least two images for a 3D presentation, available images could be processed to compensate for any misalignment or any other mismatch between camera components. It is therefore proposed that disparities between at least two available images are modified to obtain an image pair with desired disparities. The term disparity is to be understood to cover any possible kind of difference between two images, not only horizontal shifts which are relevant for determining or adjusting the ZDP. This modified image pair may then be provided for a 3D presentation.

The image modification may be used for removing undesired disparities between the images as far as possible. It is to be understood that temporal distortions can not be accommodated for. Alternatively or in addition, the image modification may be used for adjusting characteristics of a 3D presentation, like the image depth or the placement of the ZDP.

It is an advantage of the invention that it allows for a more flexible camera mounting and thus for a greater variety in the concept creation of a device comprising two camera components providing the two images. The proposed image processing is actually suited to result in higher quality 3D images than an accurate camera alignment, which will never be quite perfect due to mechanical tolerances. The invention could even be used for generating 3D images based on images that have been captured consecutively by a single camera component. It has to be noted that the misalignment between the camera components or between two image capturing positions of a single camera component still needs to be within reasonable bounds so that the image plane overlap extends over a sufficiently large area to create the combined images after image shifting and cropping. It is further an advantage of the invention that it allows for an adjustment of disparities between two images, which are due to different properties of two camera components used for capturing the pair of images. It is further an advantage of the invention that it allows equally for an adjustment of disparities between two images, which have not been captured by camera components but are available from other sources.

In one embodiment of the invention, the image modifications are applied not only to one of the available images but evenly to each image in opposite directions. This approach has the advantage that cropping losses can be reduced and that the same center of image can be maintained.

The first calibration image and the second calibration image may be the same as or different from the first available image and the second available image, respectively.

The calibration images and the available images may further be obtained for instance by means of one or more camera components.

A respective first image may be captured for instance by a first camera component and a respective second image may be captured by a second camera component. The disparities that are detected for a specific image pair may be utilized for a modification of the same specific image pair or for a modification of subsequent images if the cameras do not move relative to each other in following image pairs. The calibration image pair based on which the disparity is detected may be for instance an image pair that has been captured exclusively for calibration purposes.

If a respective first image and a respective second image are captured by two aligned camera components, information on the determined set of disparities can also be stored for later use. In the case of two fixed camera components, it can be assumed that the disparities will stay the same for some time.

Alternatively, the images may be captured in sequence by a single camera component. If the first image and the second image are captured consecutively by a single camera component, the available image pair actually has to be the same as the calibration pair.

In case a single camera is used for capturing the images, a motion of the single camera component could be detected after the first available image has been captured. An automatic capture of the second available image by the single camera component could then be triggered when a predetermined motion has been detected. The predetermined motion is in particular a predetermined motion in horizontal direction. For detecting the motion, an accelerometer or positioning sensor could be used. Thus, the user just has to move the camera in the horizontal direction and the second image will be captured automatically at the correct separation.

The detected disparities may be of different types. The disparities between two images may result for example from differences between camera positions and orientations taking these images. Other disparities may result from differences in the lenses of the cameras, etc. Scaling effects occurring from different camera optics are yet another form of disparity, which is a constant scaling over the entire image.

All types of misalignments between camera positions and orientations, including pitch, convergence, image scale, keystone, rotational, barrel, pincushion, etc., cause a combination of horizontal and vertical shifts in parts of the scene. Equally, some lens distortions may result in horizontal and vertical shifts.

Detecting existing disparities may thus comprise detecting a global vertical displacement and/or a global horizontal displacement between content of a first available image and content of a second available image. In addition, there may be a different displacement for every single object in the scene, and the disparity range may be extended or compressed horizontally, which extends or compresses the overall scene depth magnification. Thus, detecting existing disparities may further comprise detecting local vertical displacements and/or local horizontal displacements between content of a first available image and content of a second available image. Such displacements may be detected in the form of motion vectors.

In case a global vertical displacement is detected, this may indicate a pitch misalignment. Detected local vertical displacements may equally be due to a vertical position misalignment, if it is related to the object distances, or due to other small side effects from other forms of misalignments or image inconsistencies. Local vertical displacements may further be due to a convergence misalignment causing a keystone effect, due to rotation, and due to scaling, barrel distortions or pincushion distortions.

In case a global horizontal displacement is detected, this may indicate a misalignment of the camera components in horizontal direction or a convergence misalignment. Pitch misalignment causing a keystone effect, barrel distortion, pincushion distortion, etc., will result in localized horizontal displacements.

In general, a first and a second image are related to each other by Euclidian Y and Z shift, projective pitch and convergence and rotational misalignment, and induced disparity for objects relative to the object depth. To create a good 3D image, all unwanted artifacts have to be removed for obtaining matching images, leaving only the induced disparity between the images and the Euclidian shift required for moving the zero displacement plane. It is to be understood, though, that for a reduced processing complexity, only selected ones of all possible misalignment types may be considered.

By evaluating the detected displacements, a respective type of an artifact that is present in a specific image pair can be determined and compensated for.

A horizontal shift between two camera positions exceeding a predetermined amount causes undesired extension or compression of the depth field, respectively, and is thus undesirable as well. Advantageously, it is thus corrected as it makes the image seem strange. Still, such a shift is not quite as critical as vertical displacements.

Vertical shifts between two camera positions result in the only undesirable artifact that can not be corrected with standard image modifications. In this case, the vertical misalignment depends on the depth of the objects. That is, if the back of the scene is vertically aligned in both images then the front of the scene is vertically misaligned, while if the front of the scene is aligned in both images then the back is misaligned. The effect can be slightly reduced at the cost of other side effects. In a scene in which the lower part of the scene appears to be closer to an observer then the top part, the objects can partly be aligned so that they fall on each other by compressing the vertical direction of the image from the higher camera. Still, this has the side effect of differences in height of objects in the left and right image. Thus, each vertical alignment can only be a compromise to improve the overall perception. As the uncorrectable factor only comes from a vertical camera shift, this is an important factor in sequences of shots taken with a single camera. With fixed cameras, the vertical misalignment is within a millimeter so it is not a problem.

In addition to a displacement, a warping effect may be detected and compensated. Any rotational misalignment between two camera orientations, including convergence and pitch misalignment will always have a keystone effect, and so a perspective correction may be carried out as well. Knowledge about a global vertical or horizontal shift from a pitch misalignment or a convergence misalignment also provides knowledge about a vertical or horizontal keystone effect that can be accurately calculated and corrected. The displacement of an image plane from a rotation is larger than the perspective plane effect so it is easier to detect a global shift, and then not only correct the displacement but also correct the perspective shift warp in trigonometric relation to the magnitude of the displacement.

With a convergence misalignment between two camera orientations, for example, disparities arise between the left and right input image due to the non-linearity of the X axis, which depend on the X position of the object. That is, there is a different horizontal position for all objects at different depths, causing a warping of the perceived depth space. A picture of a flat object taken with converged cameras will be perceived to have the middle of the object closer and the sides further from the viewer, causing a bending effect of the flat object. A simple Euclidian global matching method will not be able to compensate efficiently for a large convergence misalignment, but only for pitch misalignment. Convergence misalignment can be detected by a change in the perspective plane. Such a change may be located by looking at the keystone distortion in the scene, comparing the vertical misalignment differences between the four corners of the scene. In addition to vertical components from keystone distortion and non-linearity of the horizontal axis mentioned above, a convergence misalignment mainly causes a horizontal shift in the scene. Horizontal shifts of the scene are not as harmful to the viewer as vertical shifts, though, as a horizontal shift will make the entire perceived scene seem closer to or farther from the viewer in the final image, but this is not severely annoying to the viewer.

Projective warping effects can be evaluated for determining a mismatch between the contents of an image pair due to a convergence misalignment. A convergence misalignment can be calculated advantageously by taking calibration pictures outdoors, where most of the scene is at close to infinite distance, hence removing the displacement components between the pictures. The effect of camera displacement is inversely proportionate to the object distance. For an object at a distance of a and cameras arranged each at a distance of b to a middle line, for example, the difference in degrees per camera from infinite setting can be calculated as arctan(b/a).

A convergence misalignment can also be calculated by taking a calibration picture from one or two points that are arranged on a line perpendicular to the camera plane, where the front point is at a known distance from the camera while the rear point is advantageously at infinite distance. This would give a more accurate convergence misalignment correction, as the convergence aspect of the misalignment can be easily separated from the disparity factor due to the intended camera separation. This approach also allows for calibrating distance gauging.

A disparity map from the images can be turned into a depth map or be used for distance gauging if the exact camera separation is known or using one point that gives the camera separation. There are many ways of doing this, some being more accurate then others. The accuracy depends on the accuracy of how well the points can be located and how well the camera positions can be located. For taking into account more degrees of freedom, obviously more information is needed to make the system accurately determinable. A depth map can be used as a basis for modifying at least one of a first available image and a second available image, and a distance gauging can be performed in the scope of modifying at least one of a first available image and a second available image.

As mentioned above, effects of X, Y and Z movements are further strongly related to the distance of an object. The movements will not be noticeable when comparing objects at infinite distance, but very noticeable when viewing close objects. Hence, angular alignment correction is best done by comparing parts of the scene at infinite distance.

The dependency of the distance can be taken into account for instance by using information about the disparity at a central point or by using a disparity map over the entire image.

A disparity map can be used more specifically for segmenting an image into distant and close parts and thus for separating horizontal and vertical effects arising from camera position displacements and rotations. Information on the distant parts may then be used for determining rotational misalignments. The determined rotational misalignments can then be minimized by modifying at least one of the images. Information on near parts, in contrast, can be used for determining motion aspects. Such translatory misalignments can then be approached to desired values by modifying at least one of the images.

The disparities dynamically detected from the content of images can be used for dynamically changing an amount of shifting, sliding and/or cropping. An automatic convergence could be easily implemented to be performed at the same time as motion detection, block matching and/or image transformations that are required for misalignment corrections.

Euclidian transformations are only a model of the perspective transformation from camera rotation, but are applicable with roughly aligned cameras as the perspective shift is very limited at small angles. Perspective transformations require floating point multipliers and more processing power, which might make the Euclidian simplification more applicable in terminal situations.

Modifying at least one image may also comprise removing barrel or pincushion distortions and all other lens artifacts from the image based on detected displacements, in order to remove the inconsistencies between the images.

In addition to the physical misalignment differences, detecting existing disparities may further comprise at least one of detecting disparities in a white balance and/or sharpness and/or contrast and/or granularity and/or a disparity in any other image property, between a first calibration image and a second calibration image. Modifying at least one available image may then comprise a matching of white balance or other colors, of sharpness and of granularity, and any other image matching that is required in order to create a matching image pair that it free from effects that would cause nausea and fatigue and that will thus be comfortable for the human eye when used in a 3D presentation.

Block matching allows calculating transition effects between the camera positions at which an image pair is captured. It can thus be used for determining the displacement between contents of image pairs. Unwanted horizontal and vertical position differences, rotational and pitch misalignment can be directly compensated for by analysis of the picture based on a global block matching operation for global shift detection or multiple point block matching and motion estimation techniques for local image disparity detection and much more accurate alignment correction models.

As mentioned before, displacements between an image pair may be different across the entire image. They will usually not be uniform displacements, as all orientation misalignments between camera components cause perspective shifts, and position misalignments between camera components cause linear shifts of every object in the scene relative to their distance from the camera. When detecting for instance horizontal displacements, they may be due to a combination between effects from the rotation and physical movement. The same applies to vertical displacements etc. Therefore, distant points can be used for rotational correction by detecting which points are in the distance.

Disparities between the first calibration image and the second calibration image could be detected for instance by comparing the first calibration image and the second calibration image by means of a disparity mapform for distinguishing between closer and farther objects in a respective image. At least one of a first available image and a second available image could then be modified by compensating for a rotational misalignment on a background and for a displacement on a foreground.

The proposed image modification allows as well a setting of a desired image depth by modifying the horizontal displacement between two images.

Further, the proposed image modification enables an automatic convergence. A physical displacement between two images causes a range of displacements between the represented objects depending on the object distance from close distance to infinite distance. Hence, it is possible to use this information to shift at least one of the images to place the ZDP in the middle of this range of displacements so that half the scene will appear in front of the screen presenting a 3D image and half will appear behind this screen. An automatic convergence allows for distant convergence in landscape scenes, and moving the ZDP forward automatically when objects come closer, meaning that the virtual convergence point comes closer. As a result, the close object does not fall out of the comfortable virtual viewing space.

An automatic convergence algorithm could pick up for instance the disparity of an object in the middle of the screen and set the disparity of the ZDP relative to the object in the middle of the screen. For example, in case of a portrait, a person is located at the center of the scene, and the center might thus be automatically set to be 50% out of the screen into the CVVS. As the person moves forwards and backwards, the ZDP can be changed to adjust to this. The concept could be even further expanded by using a disparity range picked up from multiple point block matching or a disparity map to automatically adjust the ZDP to be in the correct position. In this case, the desired disparities thus define a desired placement of a ZDP in a three-dimensional presentation, which is based on the provided first calibration image and the provided second calibration image.

In general, modifying at least one of the first available image and the second available image may comprise shifting the zero displacement plane such that an object located at a center of the images is perceived at a specific location within a CVVS in the 3D presentation. The specific location may be the middle of the CVVS or some other location, that is, it may also lie in front of the screen or behind the screen. For example, if a scene on an image comprises a person or an object in the center, and this person or this object is assumed to be one of the closest objects in the scene, and the background area at an infinite distance has a zero disparity, then the ZDP can be adjusted to place the portrait or the central object into the front area of the CVVS. On the other hand, if the scene is assumed to be a landscape scene, the object in the middle of the screen may be the horizon and is thus placed at the back area of the CVVS, while the objects at the marginal areas of the screen can be assumed to be closer and be placed into the front area of the CVVS.

Such an automatic convergence could be implemented with software, which would make it much more flexible and dynamic than any manual convergence system. The image modifications that are required for autoconvergence could be applied at the same time as image modifications that are required for misalignment corrections.

Finally, it might be noted that while normally converged cameras are undesirable as the perspective planes have to match, a perspective model correction algorithm could be used for correcting the perspective shift of converged cameras and hence allow converged cameras with perspective shift correction. This would naturally cause a slight loss of the top and lower area of the image when correcting for keystone distortion, but would save the need for substantial cropping as in parallel non-chip shifted calibrations. Ultimately, chip-shifting is an advantageous way to converge, with cropping and converging to adapt the depth of the scene, for example in nearby portrait or in scenic scenes with distant objects. Chip-shifting means that the chip of a camera comprising the sensor that is used for capturing an image is located slightly to the side of the lens. This causes the same effect as cropping the image and only using a part of the information from the chip; the perspective plane stays the same. The advantage of chip shifting is that instead of only using information from a part of the chip, the whole chip is physically moved within the camera. This means that the whole chip can be used, saving the need for any image cropping. The change in position of the chip naturally has to be very accurate, and opposite direction chip shifts should be implemented accurately in both cameras. Accurate dynamic movements of the chip position are not easy to achieve mechanically, so it might be preferred to use a fixed convergence amount. Even chip-shifted systems can benefit from having dynamic software convergence on top of the chip-shifting convergence to give the designer more control over dynamic depth changes.

The proposed apparatus may be any apparatus, which is suited to process images for a 3D presentation. It may be an electronic device, like a mobile terminal or a personal digital assistant (PDA), etc., or it may be provided as a part of an electronic device. It may comprise in addition at least one camera component and/or a stereoscopic display. It could also be a pure intermediate device, though, which receives image data from other apparatus, processes the image data, and provides the processed image data to another apparatus for the 3D presentation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a diagram illustrating the image planes resulting with two converged cameras;

FIG. 2 is a diagram illustrating the image planes resulting with two aligned cameras;

FIG. 3 is a diagram illustrating the coverage of images captured with two aligned cameras;

FIG. 4 is a diagram illustrating a perceived depth of objects in a 3D presentation;

FIG. 5 is a diagram illustrating a cropping of images captured with two aligned cameras;

FIG. 6 is a diagram illustrating the 6 degrees of freedom of a camera placement;

FIG. 7 is a diagram illustrating the CVVS of a screen;

FIGS. 8a-8f are diagrams illustrating the effect of different types misalignments of two cameras;

FIG. 9 is a schematic block diagram of an apparatus according to a first embodiment of the invention;

FIG. 10 is a flow chart illustrating an operation in the apparatus of FIG. 9;

FIG. 11 is a schematic block diagram of an apparatus according to a second embodiment of the invention; and

FIG. 12 is a flow chart illustrating an operation in the apparatus of FIG. 11.

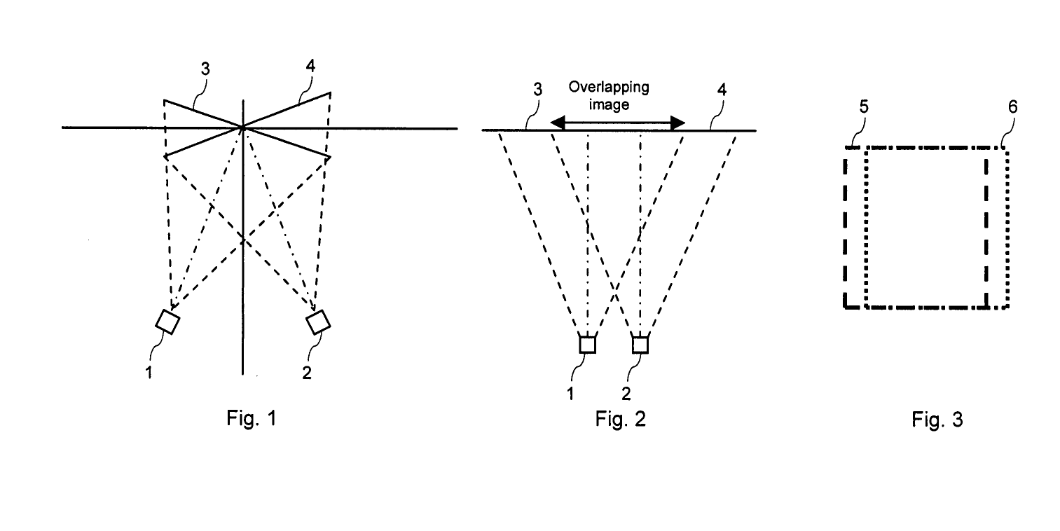

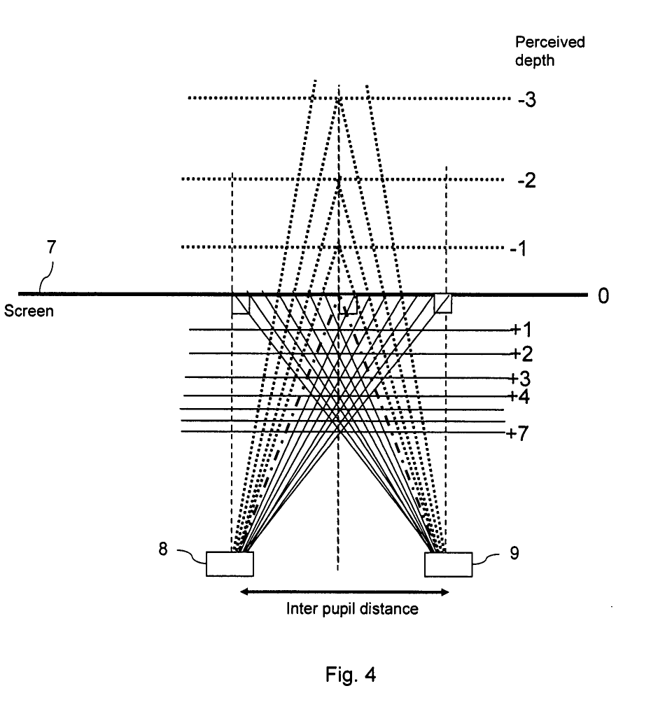

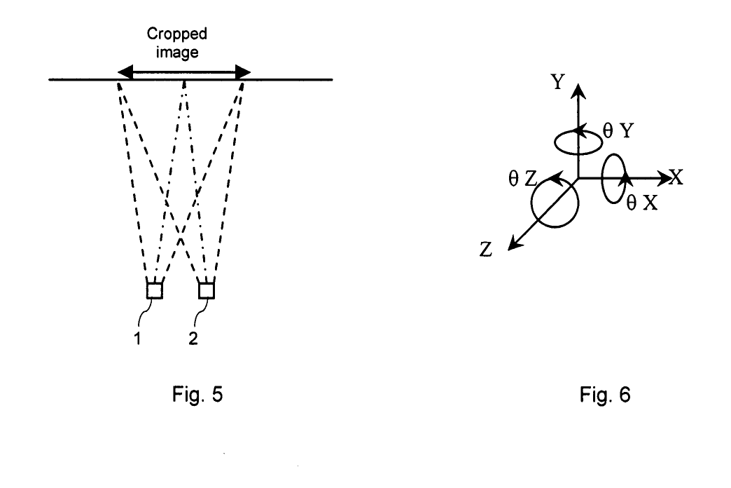

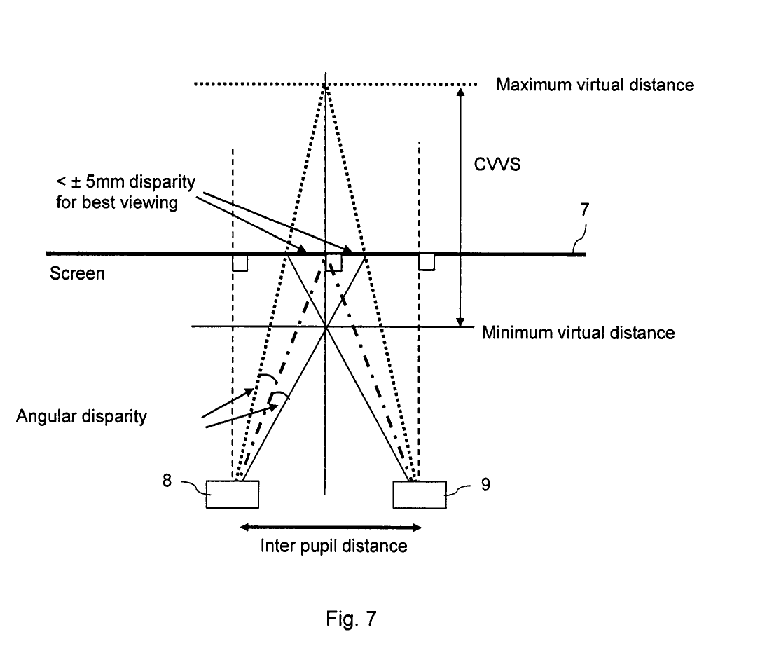

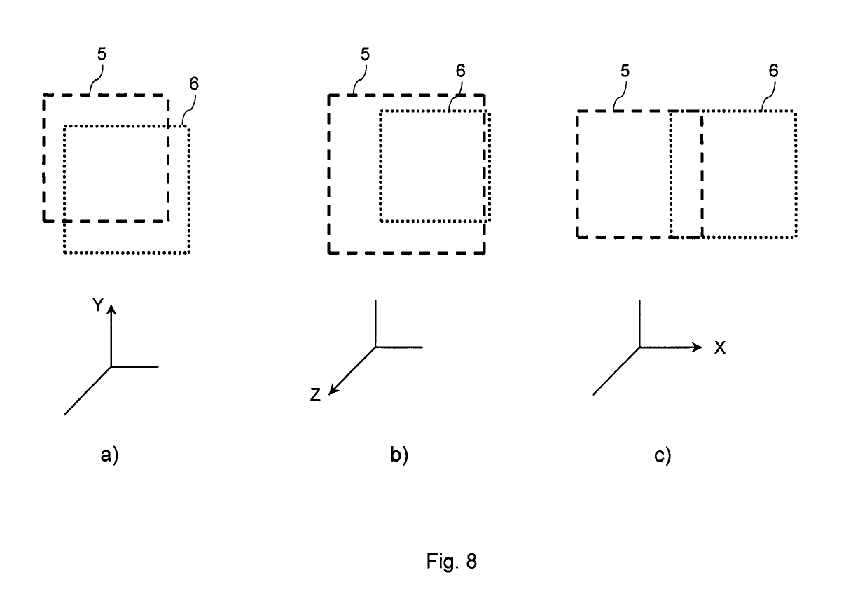

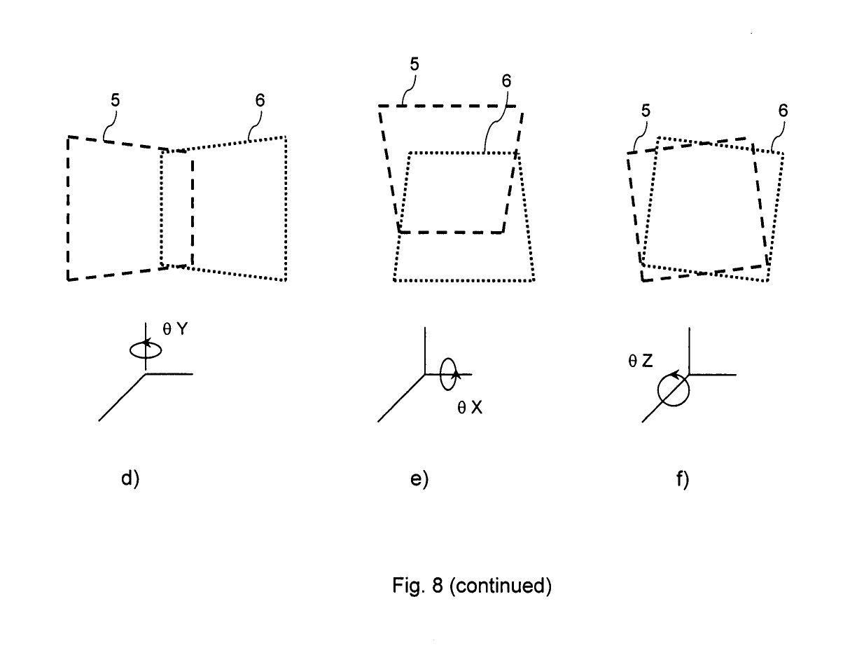

### DETAILED DESCRIPTION OF THE INVENTION

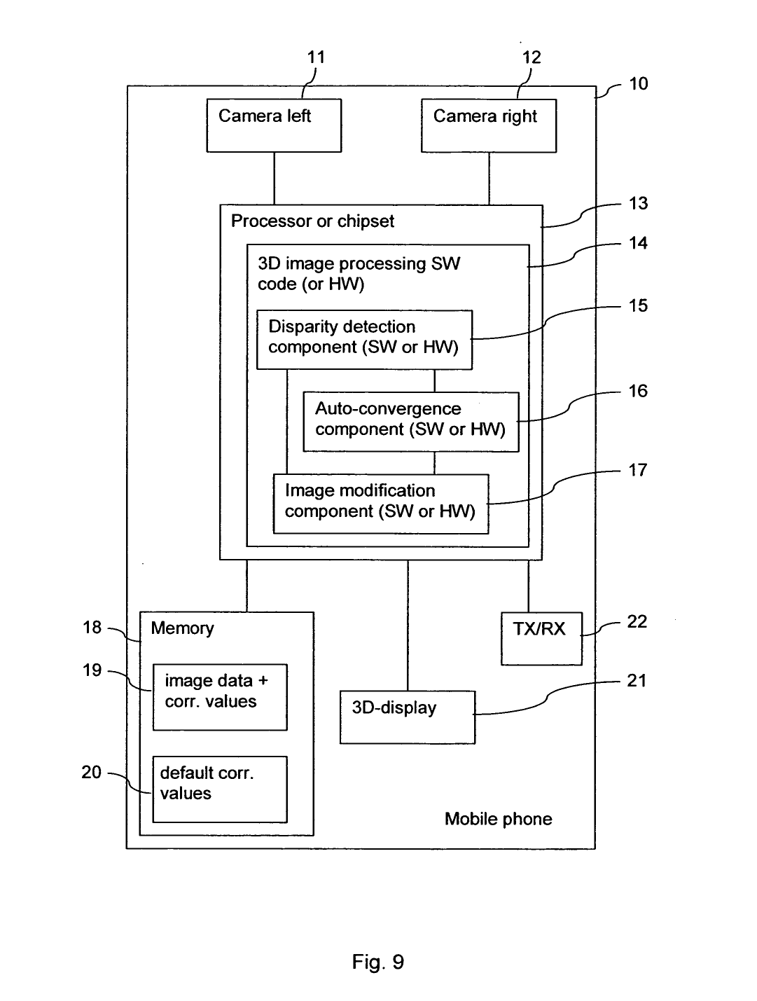

FIG. 9 is a schematic block diagram of an exemplary apparatus, which allows compensating for a misalignment of two cameras of the apparatus by means of an image adaptation, in accordance with a first embodiment of the invention.

By way of example, the apparatus is a mobile phone 10. It is to be understood that only components of the mobile phone 10 are depicted, which are of relevance for the present invention.

The mobile phone 10 comprises a left hand camera 11 and a right hand camera 12. The left hand camera 11 and the right hand camera 12 are roughly aligned at a predetermined distance from each other. That is, when applying the co-ordinate system of FIG. 6, they have Y, Z, θX, θY and θZ values close to zero. Only their X-values differ from each other approximately by a predetermined amount. Both cameras 11, 12 are linked to a processor 13 of the mobile phone 10.

The processor 13 is adapted to execute implemented software program code. The implemented software program code comprises a 3D image processing software program code 14, which includes a disparity detection component 15, an autoconvergence component 16 and an image modification component 17. It is to be understood that the functions of the processor 13 executing software program code 14 could equally be realized for instance with a chip or a chipset comprising an integrated circuit, which is adapted to perform corresponding functions.

The mobile phone 10 further comprises a memory 18 for storing image data 19 and default correction values 20. The default correction values 20 indicate by which amount images taken by the cameras 11, 12 may be adjusted for compensating for a misalignment of the cameras 11, 12. The default correction values 20 could comprise for instance a first value A indicating the number of pixels by which an image taken by the left hand camera 11 has to be moved upwards, and a second value B indicating the number of pixels by which an image taken by the right hand camera 12 has to be moved downwards, in order to compensate for a camera misalignment. Such correction values 20 enable in particular a compensation of a pitch misalignment in θX direction. The memory 18 is equally linked to the processor 13.

The mobile phone 10 further comprises a stereoscopic display 21 and a transceiver 22. The display 21 and the transceiver 22 are linked to the processor 13 as well.

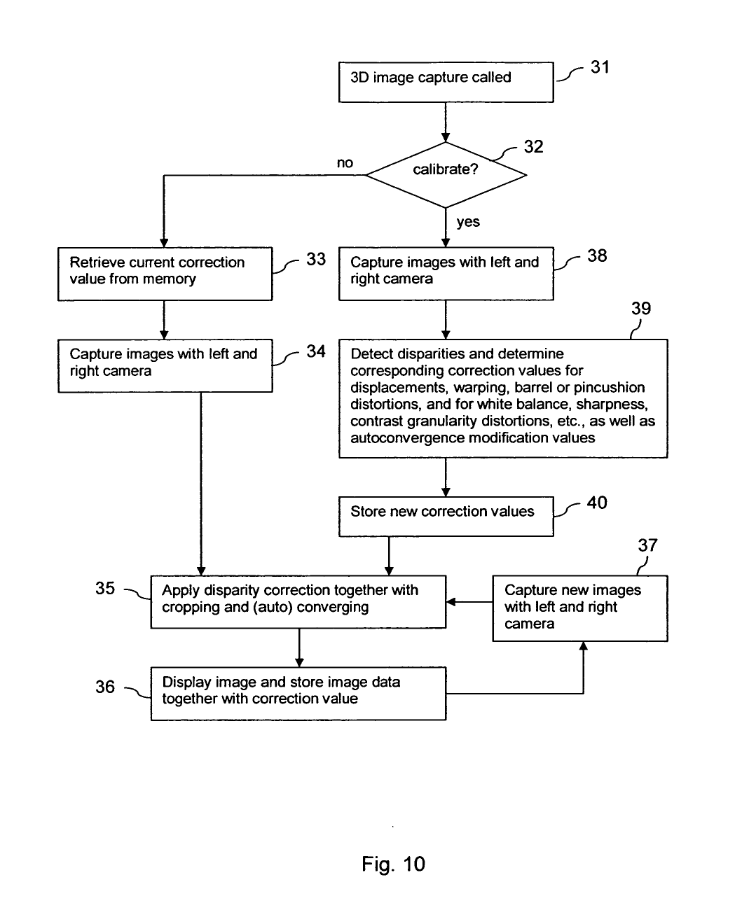

An operation of the mobile phone 10 of FIG. 9 will now be described in more detail with reference to the flow chart of FIG. 10.

When a user of the mobile phone 10 calls a 3D image capture option (step 31), the processor 13 executing the 3D image processing software program code 14 first asks the user whether to perform a calibration (step 32).

If the user selects a “no” option, the processor 13 retrieves the default correction values 20 from the memory 18 (step 33). These default correction values 20 may be for instance values that have been determined and stored when configuring the mobile phone 10 during production, or they may be values that resulted in a preceding calibration procedure requested by a user.

The user may then take a respective image simultaneously with the left hand camera 11 and the right hand camera 12 (step 34).

The image modification component 17 uses the retrieved default correction values as a basis for modifying both images in opposite direction as indicated by the correction values. This modification can be applied at the same time as various other re-sizing and horizontal shift processes that are required for a 3D image processing, including for instance a cropping and converging of the images (step 35).

The processed images may then be combined and displayed on the stereoscopic display 21 in a conventional manner (step 36). In addition, the processed image data may be stored in the memory 18. Alternatively, the original image data could be stored together with the employed default correction values. This would allow viewing the images on a conventional display with the original image size.

The user may then continue taking new images with the left hand camera 11 and the right hand camera 12 (step 37). The images are processed as the previously captured images (steps 35, 36), always using the retrieved default correction values, until the 3D image capture process is stopped.

If the user selects a “yes” option, in contrast, when being asked in step 32 whether a calibration is to be performed, the user may equally take a respective image simultaneously with the left hand camera 11 and the right hand camera 12 (step 38).

The disparity detection component 15 then detects disparities between both images and corresponding correction values (step 39). Global and local displacements can be detected for instance by means of global and local block matching operations or by motion estimation operations.

The disparity detection component 15 further determines the type of distortion that is responsible for detected displacements and suitable correction values. The considered types of distortion may comprise for instance global displacements, warping including keystone and depth warping, barrel or pincushion distortion, etc.

The disparity detection component 15 further determines other types of disparities, which do not involve any displacements, including white balance, sharpness, contrast, and granularity distortions. The disparity detection component 15 also determines correction values for these effects.

If an autoconvergence function is activated, the autoconvergence component 16 further uses the displacements detected by the disparity detection component 15 for determining the disparities of an object in the center of a scene and for determining modification values, which are suited to place the ZDP into the middle of the CVVS. This enables an adaptation of the scene so that it will automatically have a matching ZDP when viewing distant scenery, or a close one when the scene comprises for instance a portrait of a person close to the camera (step 39).

The correction values determined by the disparity detection component 15 may be stored in the memory 18 as future default correction values 20 (step 40).

The further processing is basically the same as without calibration.

Thus, the image adaptation component 17 uses the determined correction values as a basis for modifying both images in opposite direction in combination with other re-sizing and horizontal shift processes that are required for the 3D image processing (step 35). If the autoconvergence function is activated, the other processes do not include a regular converging operation, but rather an autoconverging which is based on the modification values determined by the autoconvergence component 16. Converging on nearer objects will shift the entire scene backwards in the virtual space, making it possible to fuse closer objects that would normally not be fusible. This can also be used for increasing the depth magnification of a small object by changing the depth magnification factors, and also in limiting the furthest object in the scene to be closer than infinite distance, allowing a greater depth magnification of the field, but care has to be taken that the furthest object in the scene is still fusible. Converging on more distant objects brings the distant objects forward in the perceived space, allowing for a more comfortable viewing of distant objects, other factors of depth magnification can then be implemented so to make the distant objects in the scenery seem more 3D.

The processed images may then be combined and displayed on the stereoscopic display 21 (step 36). In addition, the processed image data or the original image data and the determined correction values may be stored in the memory 18.

If the autoconvergence function is deactivated, the user may then continue capturing new images with the left hand camera 11 and the right hand camera 12 (step 37). The images are processed as the previously captured images (steps 35, 36), always using the determined correction values, until the 3D image capture process is stopped.

If the autoconvergence function is activated, the operation continues with step 38 instead of with step 37, since the autoconvergence function depends not only on the rather stable position, orientation and properties of the camera components 11, 12, but equally on the distribution of the objects in the captured scene.

It is to be understood that the embodiment could not only be used for processing 3D pictures, but equally for processing 3D videos. In this case, the correction values could be determined based on a first pair of image of the video captured by two cameras 11, 12, while all image pairs of the video are adapted based on these correction values, just as in the case of a sequence of distinct pictures.

The image data 19 stored in the memory 18 could also be transmitted to some other device via transceiver 22. Further, 3D image data could be received via transceiver 22. The user could then equally be asked whether to perform a calibration. If the user selects an option “no”, the images have to be presented without any misalignment correction, as the stored default correction values 20 are not suited for other devices. If the user selects an option “yes”, steps 38-40 and 35-37 could be performed in the same manner as with images captured by the integrated cameras 11, 12.

As mentioned further above, camera misalignments may be present in various directions. Camera misalignments in the rotational and vertical directions have the most severe effects, as they cause large fusion problems and drastically increase the eye-strain when viewing the 3D image. Horizontal shifts between the contents of images are undesirable as they warp and distort the scene, but they are not quite as critical as vertical shifts between the contents of images resulting from vertical and pitch misalignments of the cameras. The image adaptation may be designed specifically for pitch misalignment, since the vertical positions of the cameras may be located fairly accurately, while a pitch misalignment of the cameras by just a fraction of one degree may result in large vertical shifts between the contents of captured images. Further, transition effects due to vertical shifts are relative to the 3D geometry and can thus not be fully compensated with any form of projective or conventional image transformations.

As indicated above with reference to FIG. 6e), rotation along the pitch axis causes a vertical shift, a slight non-linearity along the vertical axis and keystone distortion. The keystone distortion is relative to sin(φ), and with aligned cameras, a misalignment of a fraction of one degree will cause limited keystone distortion. In order to limit the complexity of an algorithm that is used for the disparity detection and compensation and the required processing power, small angles may be assumed and the projective transformation may be simplified to a vertical shift.

Such an algorithm may be an implementation of a vertical global block matching, which is used to compare the two input images and output the number of pixels vertical difference between the left and right images. For detecting a vertical shift between the content of the captured images due to a misalignment of the cameras 11, 12, for instance a global least squares vertical shift block matching may be employed.

The search range that is covered by the block matching should be large enough to cover the maximum expected misalignment. If the misalignment is greater then the search range then there will be a mismatch local minimum, but having a too large search range would unnecessarily slow down the algorithm.

A small search range may be employed in case fixed dual camera systems are aligned within mechanical tolerances. In this case, alignment calibration may be done once at the start of operation, and this calibration may then be used for all the following images taken. A significantly larger search range is needed if the cameras are not physically aligned within physical tolerances. In this case, it would also not be appropriate to use a Euclidian approximation, as keystone distortion has to be taken into account as well.

The block matching may result in the exact number of pixels or sub-pixels, by which the contents of the images are shifted against each other in vertical direction.

The image adaptation may be suited to compensate for a pitch misalignment to a significant extent. With a suitable block matching, the misalignment can be reduced to ±0.5 pixel, or even less in case a sub-pixel block matching is used. This is far more accurate then any mechanical alignment tolerance, and hence produces better-aligned images as a basis for a 3D presentation.

The presented first embodiment is intended specifically for the constraints of a mechanically aligned system. It has to be noted that different implementations of the concept would be appropriate for different use cases. Euclidian shifts in X and Y direction drastically improve this model with nearly aligned cameras. An extension to a projective model can also be implemented with improved motion estimation algorithms. This may even allow using a single camera to take multiple pictures in succession and then using image adaptation to match the images and create appropriate alignment and disparity ranges, assuming that temporal distortions and movements in the scene are limited.

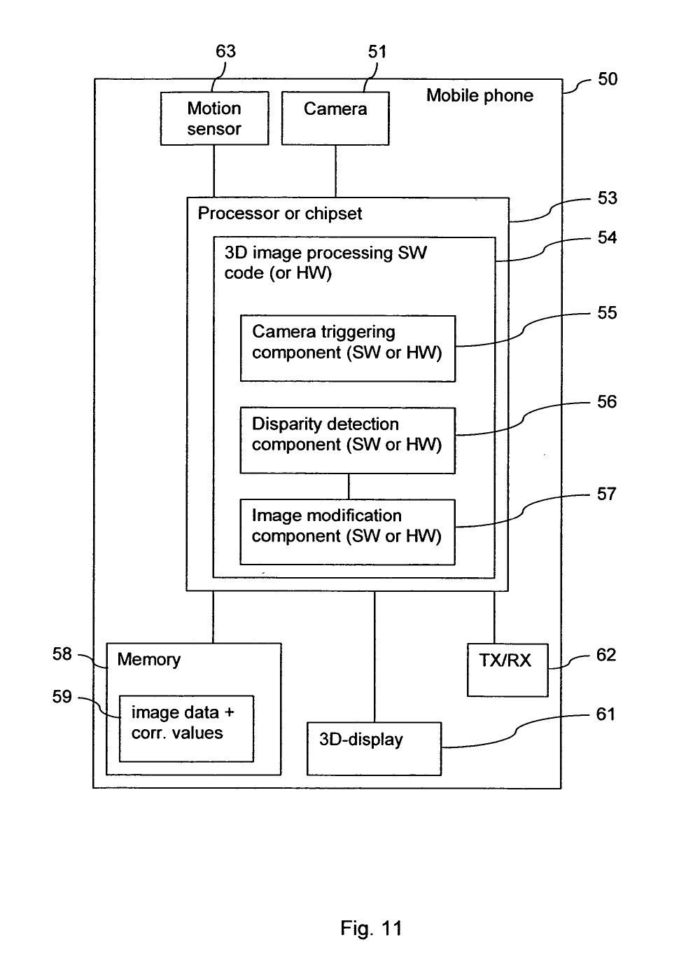

FIG. 11 is a schematic block diagram of an exemplary apparatus according to an embodiment of the invention, which allows compensating for undesired motion while capturing images for a 3D presentation with a single camera.

By way of example, the apparatus is a mobile phone 50. It is to be understood that only components of the mobile phone 50 are depicted, which are of relevance for the present invention.

The mobile phone 50 comprises a single camera 51, which is linked to a processor 53 of the mobile phone 50. The processor 53 is adapted again to execute implemented software program code. The implemented software program code comprises a 3D image processing software program code 54 including a camera triggering component 55, a disparity detection component 56, and an image modification component 57. It is to be understood that the functions of the processor 53 executing software program code 54 could equally be realized for instance with a chip or a chipset comprising an integrated circuit, which is adapted to perform corresponding functions.

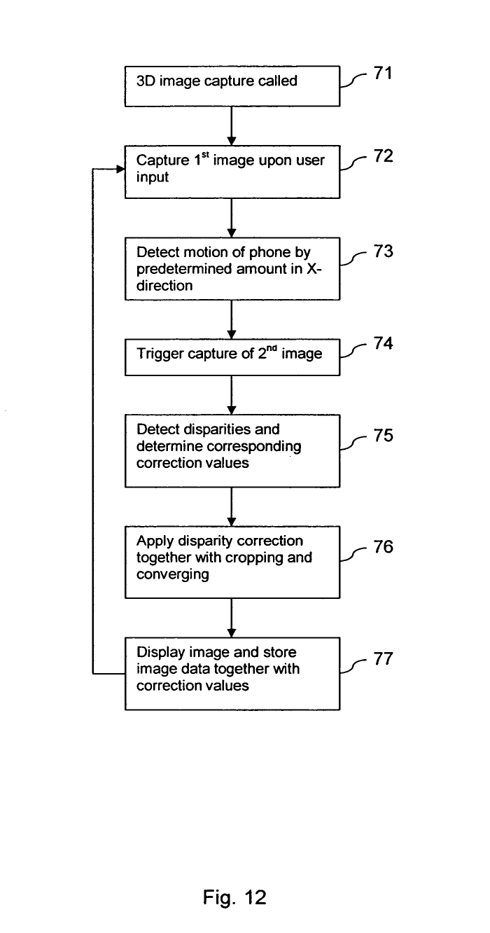

The mobile phone 50 further comprises a memory 58 for storing image data 59. The memory 58 is equally linked to the processor 53. The mobile phone 50 further comprises a stereoscopic display 61, a transceiver 62 and a motion sensor 63. The display 61, the transceiver 61 and the motion sensor 63 are linked to the processor 53 as well. An operation of the mobile phone 50 of FIG. 11 will now be described in more detail with reference to the flow chart of FIG. 12.

When a user of the mobile phone 50 calls a 3D image capture option (step 71), the processor 53 executing the 3D image processing software program code 54 asks the user to take a picture with the single camera 51. The user may then take this pictures (step 72). When being asked to take the picture, the user may be reminded to try to move the mobile phone 50 only in X-direction after having taken the picture.

Once the user has taken a picture, the motion sensor 63 detects the movement of the mobile phone 50 (step 73) and informs the camera triggering component 55 accordingly. When the camera triggering component 55 detects that the mobile phone 50 has been moved by a predetermined amount in horizontal direction, it triggers the camera 51 to take a further picture (step 74).

An inquiry whether a calibration is desired is not required, because a 3D presentation would not make sense based on images taken by a single camera 51 without any motion correction or with default correction values.

The disparity detection component 56 performs global and local block matching operations for detecting global and local vertical and horizontal shifts between the contents of the two captured images due to the motion of camera 51. Based on these detected shifts, the disparity detection component 55 determines correction values, which are suited to compensate for the unintentional part of the motion of the camera 51 (step 75). It is to be understood that the shift in X direction between the contents of the images resulting from the predetermined camera distance has to be maintained in order to obtain the 3D effect with a desired depth.

The image modification component 57 modifies both images as indicated by the determined correction values. This may be carried out in combination with other re-sizing and horizontal shift processes that are required for a 3D image processing (step 76).

It has to be noted that compared to an algorithm that may be employed for the first embodiment described with reference to FIG. 9, additional types of distortions and larger amounts of distortion should be taken into account. For example, the block matching range should be much larger, and also keystone distortions should be taken detected and compensated for.

The processed images may then be combined and displayed on the stereoscopic display 61 (step 77). In addition, the processed images data or the original image data and the employed motion correction values may be stored in the memory 58.

In case the user desires capturing further images for other 3D presentations, the process has to be continued with step 72, since determined motion correction values are valid only for a respective pair or sequence of images.

The image data 59 stored in the memory 58 could also be transmitted to some other device via transceiver 52. Further, 3D image data could be received via transceiver 52. The user could then be asked whether to perform a calibration. If the user selects an option “no”, the images are presented without any image adaptation. If the user selects an option “yes”, steps 73 through 77 could be performed in the same manner as with images captured by the integrated camera 51. It is to be understood that the disparity detection (step 75) and image modification (step 76) are also suited for a correction of a misalignment of two cameras capturing a pair of images, as the cameras 11, 12 of mobile phone 10.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for supporting a three-dimensional presentation on a display, which presentation combines at least a first available image and a second available image, said method comprising:
detecting disparities between a first calibration image and a second calibration image; and
modifying at least one of a first available image and a second available image to approach desired disparities between said first available image and said second available image based on said detected disparities between said first calibration image and said second calibration image.

2. The method according to claim 1, further comprising storing information on said detected disparities for a modification of further available images.

3. The method according to claim 1, wherein said first calibration image and said first available image are the same, and wherein said second calibration image and said second available image are the same.

4. The method according to claim 1, wherein said first calibration image and said second calibration image, respectively, are different from said first available image and said second available image, respectively.

5. The method according to claim 1, wherein said first calibration image and said first available image are captured by a first camera component and wherein said second calibration image and said second available image are captured by a second camera component.

6. The method according to claim 3, wherein said first available image and said second available image are captured in sequence by a single camera component.

7. The method according to claim 6, further comprising detecting a motion of said single camera component after said first available image has been captured, and triggering an automatic capture of said second available image by said single camera component when a predetermined motion has been detected.

8. The method according to claim 1, wherein detecting disparities comprises at least one of
detecting a global vertical displacement between content of said first calibration image and content of said second calibration image;
detecting local vertical displacements between content of said first calibration image and content of said second calibration image;
detecting a global horizontal displacement between content of said first calibration image and content of said second calibration image; and
detecting local horizontal displacements between content of said first calibration image and content of said second calibration image.

9. The method according to claim 1, wherein detecting disparities comprises at least one of
detecting disparities in a white balance between said first calibration image and said second calibration image;
detecting disparities in sharpness between said first calibration image and said second calibration image;
detecting disparities in contrast between said first calibration image and said second calibration image; and
detecting disparities in granularity between said first calibration image and said second calibration image.

10. The method according to claim 1, wherein modifying at least one of said first available image and said second available image to approach desired disparities between said first available image and said second available image comprises compensating for undesired detected disparities.

11. The method according to claim 1, wherein modifying at least one of said first available image and said second available image to approach desired disparities between said first available image and said second available image comprises at least one of:
compensating for a global horizontal displacement between content of a first available image and content of a second available image;
compensating for a global vertical displacement between content of a first available image and content of a second available image;
compensating for a global rotational displacement between content of a first available image and content of a second available image;
compensating for horizontal warping between content of a first available image and content of a second available image;
compensating for vertical warping between content of a first available image and content of a second available image;
compensating for a barrel distortion in a first available image or a second available image;
compensating for a pincushion distortion in a first available image or a second available image;
compensating for disparities in a white balance between a first available image and a second available image;
compensating for disparities in sharpness between a first available image and a second available image;
compensating for disparities in contrast between a first available image and a second available image; and
compensating for disparities in granularity between a first available image and a second available image.

12. The method according to claim 1, wherein detecting disparities between said first calibration image and said second calibration image comprises comparing said first calibration image and said second calibration image by means of a disparity mapform for distinguishing between closer and farther objects in a respective image, and wherein modifying at least one of said first available image and said second available image comprises compensating for a rotational misalignment on a background between said first calibration image and said second calibration image and for a displacement on a foreground between said first calibration image and said second calibration image.

13. The method according to claim 3, wherein said desired disparities define a desired placement of a zero displacement plane in said three-dimensional presentation.

14. The method according to claim 13, wherein modifying at least one of said first available image and said second available image comprises shifting said zero displacement plane such that an object located at a center of said images is perceived at a specific location within a comfortable virtual viewing space in said three-dimensional presentation.

15. The method according to claim 1, wherein for detecting said disparities, at least one of the following is employed:
a global block matching for detecting global displacements between content of said first calibration image and content of said second calibration image;
multiple point block matching for detecting local displacements between content of said first calibration image and content of said second calibration image; and
motion estimation for detecting local displacements between content of said first calibration image and content of said second calibration image.

16. The method according to claim 1, wherein said detected disparities between a first calibration image and a second calibration image are assembled in a disparity map that is used as a basis for said modifying at least one of a first available image and a second available image.

17. The method according to claim 16, wherein said disparity map is at least one of converted into a depth map that is used as a basis for modifying at least one of a first available image and a second available image; and
used for distance gauging in the scope of modifying at least one of a first available image and a second available image.

18. The method according to claim 16, wherein said disparity map is used for segmenting said three-dimensional presentation into distant and close parts, at least one of
information on distant parts being used for determining rotational misalignments that are minimized by said modifying at least one of a first available image and a second available image; and
information on near parts being used for determining translatory misalignments that are approached to desired values by said modifying at least one of a first available image and a second available image.

19. An apparatus, wherein for supporting a three-dimensional presentation on a display, which presentation combines at least a first available image and a second available image, said apparatus comprises:
a disparity detection component configured to detect disparities between a first calibration image and a second calibration image; and
an image adaptation component configured to modify at least one of a first available image and a second available image to approach desired disparities between said first available image and said second available image based on said detected disparities between said first calibration image and said second calibration image.

20. The apparatus according to claim 19, further comprising at least one camera component configured to capture a respective first image and a respective second image.

21. The apparatus according to claim 19, further comprising a stereoscopic display configured to present a three-dimensional image combining at least a first available image and a second available image.

22. A software program product, in which a software program code for supporting a three-dimensional presentation on a display is stored in a readable medium, wherein said presentation combines at least a first available image and a second available image, said software program code realizing the following when executed by a processor:
detecting disparities between a first calibration image and a second calibration image; and
modifying at least one of a first available image and a second available image to approach desired disparities between said first available image and said second available image based on said detected disparities between said first calibration image and said second calibration image.

23. An apparatus comprising:
means for detecting disparities between a first calibration image and a second calibration image; and
means for modifying at least one of a first available image and a second available image to approach desired disparities between said first available image and said second available image based on said detected disparities between said first calibration image and said second calibration image.

24. The apparatus according to claim 23 further comprising means for supporting a three-dimensional presentation on a display based upon a combination of at least said first available image and said second available image.

25. The apparatus according to claim 24, further comprising at least one camera component configured to capture a respective first image and a respective second image.
